(19) United States
(12) Patent Application Publication
(10) Pub. No.: US 2009/0063780 A1
(43) Pub. Date: Mar. 5, 2009

(54) DATA PROCESSING SYSTEM AND METHOD FOR MONITORING THE CACHE COHERENCE OF PROCESSING UNITS

(75) Inventors: Andrei Sergeevich Terechko, Eindhoven (NL); Jayram Moorkanikara Nageswaran, Eindhoven (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/577,592

(22) PCT Filed: Oct. 17, 2005
(86) PCT No.: PCT/IB05/53395

§ 371 Date: Apr. 19, 2007

(30) Foreign Application Priority Data
Oct. 19, 2004 (EP) 04105142.6

(51) Int. Cl. G06F 12/08; G06F 12/00

(52) U.S. Cl. 711/141; 711/147; 711/E12.001; 711/E12.026

(57) ABSTRACT

The present invention relates to a data processing system with a plurality of processing units (PU), a shared memory (M) for storing data from said processing units (PU) and an interconnect means (IM) for coupling the memory (M) and the plurality of processing units (PU). At least one of the processing units (PU) comprises a cache memory (C). Furthermore, a transition buffer (STB) is provided for buffering at least some of the state transitions of the cache memories (C) of said at least one of said plurality of processing units (PU). A monitoring means (MM) is provided for monitoring the cache coherence of the caches (C) of said plurality of processing units (PU) based on the data of the transition buffer (STB), in order to determine any cache coherence violations.

The invention relates to a data processing system with a plurality of processing units, a shared memory for storing data from said processing units and an interconnect means for coupling the shared memory to the plurality of processing units. The invention is also related to a method for monitoring the cache coherence of a plurality of processing units.

In today's system-on chip a plurality of processing units share a memory which can be respectively accessed by the processing units via some kind of interconnect. Such interconnect is typically a processing unit-to-memory interconnect which may be a simple bus or a complex point-to-point network on chip. The processing units often contain cache memories. A cache is a hardware managed on-chip memory, which hide long memory latency and save external DRAM bandwidth. If multiple caches exist in the IC, they should be synchronized to deliver correct data to the processing units. This problem is known as cache coherence. Modern multiprocessor integrated circuits like Intel Montecito, IBM Power 5, Philips Viper PNX8550, Sun MAJC, etc., typically comprise millions of transistors such that it is becoming more and more difficult to verify the design thereof. It is desirable to find any kind of hardware logical bugs as soon as possible, in order to either find a workaround for it without re-fabrication or fix the hardware and have the chip quickly re-fabricated. This way time-to-market is saved.

The technique for finding any hardware bugs is typically called debugging. Some modem and complex integrated circuits include test and debug facilities which may be embodied as breakpoint modules. Such modules are typically activated on a certain event like a load from a certain memory region or the like. The IC clock is stopped in order to carefully examine some of the internal registers and memories of the IC. Each integrated circuit will comprise a joint test access group JTAG interface for performing the examination of the integrated circuit. The JTAG is an IEEE 1149 standard.

Breakpoint modules, however, only work for a specified set of events which needs to be determined during design time. Such breakpoint modules have a limited view on the hardware of the integrated circuit. A breakpoint module may monitor the address signals on a bus and a breakpoint is performed as soon as a certain address be accessed to the bus. These breakpoints modules are a hardware debugging solution and allow to examine selected signals in the IC. Accordingly, only those bugs can be found by such breakpoint modules which are in a way anticipated at design time. Any other bugs will not be found by such breakpoint modules.

In “Dynamic Verification of Cache Coherence Protocol” by Cantin et al. in Workshops on Memory Performance Issues, June 2001, a method for improving the fault tolerance of cache coherent multiprocessors is disclosed. By dynamically verifying cache coherence operations in hardware, errors caused by manufacturing faults, soft errors and design mistakes can be detected. Accordingly, a hardware dynamic verification of the cache coherence of the different processing units within a multiprocessing environment is performed. Each processing unit within the multiprocessor comprises a hardware coherence checking unit and an additional validation bus to communicate the state transitions among the respective processing units. However, such an approach will result in an additional bus and in a more complex structure of the respective processing units. Furthermore, the verification hardware will add additional verification and design efforts for implementing such verification hardware.

In “Dynamic Verification of End-to-End Multiprocessor Invariants” by Sorin et al., In the Proceedings of the International Conference on Dependable Systems and Networks, in San Francisco, Jun. 22-25, 2003, another verification method using a distributed signature analysis is disclosed. Here, each coherent processing unit dynamically creates a signature which contains at least some of its state transitions. The signatures are collected centrally and a verification for protocol violations, i.e. invariants, is performed. However, this technique requires a dedicated infrastructure for distribution of the signatures, resulting in additional hardware complexity.

It is therefore an object of the invention to provide a data processing system as well as a method for monitoring the cache coherence of different processing units which allow an improved monitoring facility for the cache coherence of different processing units.

This object is solved by a data processing system according to claim 1 as well as a method for monitoring the cache coherence of different processing units according to claim 9.

Therefore, a data processing system with a plurality of processing units, a shared memory for storing data from said processing units and an interconnect means for coupling the memory and the plurality of processing units is provided. At least one of the processing units comprises a cache memory. Furthermore, a transition buffer is provided for buffering at least some of the state transitions of the cache memories of said at least one of said plurality of processing units. A monitoring means is provided for monitoring the cache coherence of the caches of said plurality of processing units based on the data of the transition buffer, in order to determine any cache coherence violations.

Accordingly, none of the processing units has to keep track of the state transitions in order to verify the cache coherence of the caches of the processing units. In contrast this is performed by a monitoring means such that the design of the processing units can be left unchanged and this design can be easily scaled.

According to an aspect of the invention, the monitoring means is adapted to signal if a violation of the cache coherence protocol has occurred, such that such a violation can be dealt with.

According to a further aspect of the invention, the monitoring means initiates the patching of the bug underlying the determined cache coherence violation at run-time, i.e. without the need for stopping and redesigning the data processing system.

According to another aspect of the invention, the monitoring means is implemented as a software monitor in one of said plurality of processing units. Therefore, the monitoring means can be re-programmable and flexible.

According to still a further aspect of the invention, the state transition buffer is arranged in the interconnect means, wherein the interconnect means updates the transition buffer. Accordingly, no extra signaling from the processing units is required as the information on the state transitions is obtained from the interconnect.

According to a further aspect of the invention, the monitoring means is implemented on a dedicated processing unit and the transition buffer is implemented as memory mapped input/output register in said dedicated processing unit.

According to a further aspect of the invention, the verification of a bug or a cache coherence violation is performed based on history data of the state transitions stored in the transition buffer and/or the shared memory. As a transition buffer will only have a limited size, some of the history data of the state transitions may be stored in the shared memory such that an analysis can be performed regarding the cache coherence violations over a longer period of time.

The invention is also related to a method for monitoring the cache coherence of a plurality of processing units within a data processing system wherein at least some of the processing units comprise a cache memory and are connected to a shared memory via an interconnect means. The state transitions of cache memories of said processing units are buffered and the cache coherence of cache memories of said plurality of processing units is monitored based on the buffered data of the state transitions.

The invention is based on the idea to monitor the correctness of the cache coherence protocol. The state transitions of the processing units are buffered in a transition buffer. A monitoring means monitors the buffered state transitions to find any unacceptable state transitions. If such an unacceptable state transition is discovered, the monitoring means may initiate an error notice or may initiate the patching of the discovered bug.

Accordingly, even functional hardware bugs within a complex integrated circuit can be resolved even after the fabrication of the integrated circuit. This is done at run-time on the fly. Accordingly, this is a very flexible and comprehensive mechanism as compared to prior art techniques. Such a mechanism is able to find and resolve any bug in the hardware cache coherence logic resulting in a protocol violation.

These and other aspects of the invention area apparent from and will be elucidated with reference to the embodiments described hereinafter.

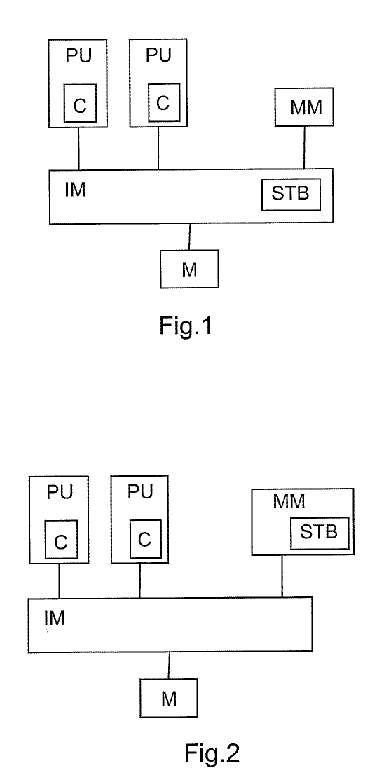

FIG. 1 shows a block diagram of a multiprocessor environment according to a first embodiment;

FIG. 2 shows a block diagram of a multiprocessor environment according to a second embodiment; and

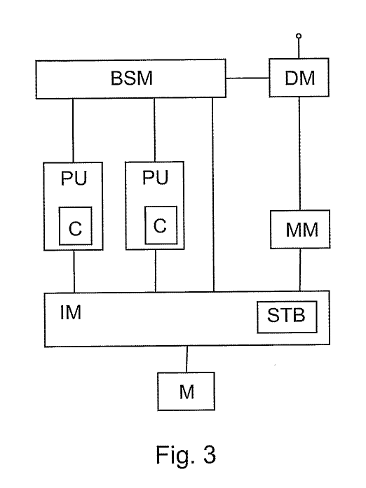

FIG. 3 shows a block diagram of a multiprocessor environment according to a third embodiment.

FIG. 1 shows a block diagram of the basic arrangement of a multiprocessor environment according to the first embodiment. Here, a plurality of processing units PU, an interconnect means IM and a memory M is shown. Furthermore, a monitoring means MM and a transition buffer STB is also shown. The transition buffer STB is arranged at the interconnect means IM and the monitoring means MM is connected to the interconnect means IM. Some of the processing units PU also comprise a cache memory C. Such a cache memory C may be a level 1 cache and constitutes hardware managed on-chip memory, which hide long memory latency and save external DRAM bandwidth. If multiple caches exist in the IC, they should be synchronized to deliver correct data to the processing units.

The cache state transitions are extracted from the interconnect transactions. The transition buffer STB serves to capture the state transitions of the caches of the processing units PU. In order to ensure the correct processing of the processing units PU a cache coherence protocol is implemented. The monitoring means MM accesses the transition buffer STB and examines the state transitions in order to find any violations in the cache coherence protocol. If a violation of the cache coherence protocol is found by the monitoring means MM, it may either signal this error or initiate the patching of the underlying bug.

The monitoring means MM can be implemented as a software monitor on a programmable processing unit. Alternatively, the monitoring means may also be implemented as a dedicated processing unit PU.

The transition buffer STB according to the first embodiment is arranged close to the interconnect. It may be implemented as a FIFO with one write port for the processing units PU and one read port for the monitoring means MM.

FIG. 2 shows a block diagram of a multiprocessor environment according to a second embodiment. Here, a plurality of processing units PU, an interconnect means and a memory M is shown. In addition, a monitoring means MM with a transition buffer STB is depicted. Accordingly, in contrast to the first embodiment, the monitoring means MM and the transition buffer STB are both implemented in one unit. Preferably, the transition buffer STB is implemented as a memory mapped input/output register MMIO. As in the first embodiment, the interconnect means IM will automatically update the state transition in the cache coherent processing units.

The monitoring means MM according to the first or second embodiment is adapted to detect cache coherence protocol violations. For the MSI protocol with the state Modified, Shared and Invalid cache coherence protocol violations may result from multiple cache lines in a modified state or a modified cache line exists in the shared state in another cache (C) of a processing unit (PU). For more information on the cache coherence protocol please refer to “Computer Architecture” by John L. Hennessy & David Patterson, 3 rd edition, Else Vier Science, 2003; Chapter 6.3-6.4. Accordingly, the transition buffer STB may be used to record or store the cache coherent processing unit identification number, the transition identification number like modified-to-shared, shared-to-invalid, etc. and the address of the processing unit.

The monitoring means MM examines the history of the state transitions in order to find any cache coherence protocol violations. The monitoring means MM stores state transitions from the transition buffer STB to the shared memory M to create history data of the state transitions over a longer period of time such that also long term cache coherence violations can be detected. Later the monitoring means MM examines the whole history of state transitions stored in memory M and transition buffer STB to detect violations.

The above described scheme is in particular valid for cache coherent multiprocessors, if these multiprocessors are related to a cache coherence protocol. The protocols are typically simple and merely have a few invariants.

FIG. 3 shows a block diagram of a multiprocessor environment according to a third embodiment. In addition to the processing units PU, the interconnect means IM, the memory M and the monitoring means MM, a boundary scan means BSM and a debugging means DM are provided.

The third embodiment which may be based on the first or second embodiment the bugs, i.e. the cache coherence violation as determined by the monitoring means MM are patched on-the-fly, i.e. directly after they have been discovered. The hardware debug engineer finds a hardware bug (possibly with the help of the monitoring means MM). Then the monitor is updated with the patch that is executed upon a detection of the hardware bug by the monitoring means. In other words, the debugging is performed at run-time. In order to determine the location of the discovered bug, a scan-chain or a boundary scan is performed by the boundary scan means BCM. The boundary scan is described in the IEEE 1149.1 standard. A chip with the multiprocessor environment typically comprises a joint test access group JTAG interface. During a standard operation the boundary cells are inactive and allow data to be propagated through the multiprocessing environment. However, during test modes all input signals are captured for analysis and all output signals are reset to test the operation of the scan cell which is controlled through the port TAP (Test Access Port) controller and an instruction register. The debugging means DM is then used for modifying those parts in the boundary chain which are related to the detected cache coherence violation or the detected bug.

Therefore, in a data processing system comprising a plurality of processing units, a shared memory and an interconnect means for coupling the plurality of processing units and the shared memory, a boundary scan unit is provided for performing a boundary scan. In addition, a debugging means is provided to modify a part of the boundary scan in order to correct a bug in the logic of the data processing system.

The advantage of such a system is that the system is scalable; it uses less area with less power for even a great number of processing units. No additional bus is required and it is a flexible and easy to modify solution due to the software monitored.

Alternatively or additionally to storing state transitions in the transition buffer, at least some of the state transitions can be stored in the cache memories C.

Although the above-mentioned embodiments have been described with regard to a cache coherence protocol for caches which are arranged at the processing units, i.e. level 1 caches, the basic principle of the invention is also applicable for level 2 caches or level 3 caches. Here, also a transition buffer for storing the state transitions of the caches which are involved in the cache coherence protocol and a monitoring means for monitoring the stored state transitions in order to determine any cache coherence violations

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

Furthermore, any reference signs in the claims shall not be construed as limiting the scope of the claims.

1. Data processing system, comprising
a plurality of processing units, wherein at least one of said plurality of processing units comprises a cache memory,
a shared memory for storing data from said plurality of processing units,
an interconnect means for coupling said shared memory and said plurality of processing units,
a transition buffer for buffering state transitions of at least one cache memory of said plurality of processing units, and
a monitoring means for monitoring the cache coherence of said at least one cache memory of said plurality of processing units based on the state transitions buffered in the transition buffer, in order to determining cache coherence violations.

2. Data processing system according to claim 1, wherein said monitoring means is adapted to signal a notification in case a cache coherence violation is determined.

3. Data processing system according to claim 1, wherein said monitoring means is adapted to patch the determined cache coherence violation at run-time.

4. Data processing system according to claim 3, further comprising a boundary scan means for performing a boundary scan on internal registers of the data processing system; and
a debugging means for modifying a faulty part of the boundary chain.

5. Data processing system according to claim 1, wherein the monitoring means is implemented on a programmable processing unit in software.

6. Data processing system according to claim 5, wherein the transition buffer is arranged at the interconnect means wherein said interconnect means updates the transition buffer.

7. Data processing system according to anyone of the claims 1 to 3, wherein the monitoring means is implemented on a programmable processing unit, wherein the transition buffer is arranged in the monitoring means as a memory mapped input/output register.

8. Data processing system according to claim 1, wherein state transitions are also stored in said shared memory, and wherein said monitoring means is adapted to verify a violation of the cache coherence protocol based on history data of the state transitions stored in said transition buffer and/or said shared memory.

9. Method for monitoring the cache coherence of a plurality of processing units within a data processing system which are connected to a shared memory via an interconnect means, wherein at least one of said plurality of processing units comprises a cache memory, comprising the steps of:
buffering state transitions of at least one cache memory of said plurality of processing units, and
monitoring the cache coherence of said at least one cache memory of said plurality of processing units based on the buffered state transitions, in order to determine cache coherence violations.

10. Method according to claim 9, wherein the cache coherence of said at least one cache memory is monitored based on history data of the state transitions.

11. Method according to claim 9, wherein state transitions are stored in at least one of said cache memories or in a transition buffer.

12. Data processing system, comprising
a plurality of processing units;
a shared memory for storing data from said plurality of processing units;
an interconnect means for coupling the shared memory, and said plurality of processing units;
a boundary scan means for performing a boundary scan on the internal of the data processing system; and
a debugging means for modifying a faulty part of the boundary chain at run-time.

13. Data processing system according to claim 11, further comprising a transition buffer for buffering state transitions of at least one cache of said plurality of processing units and
a monitoring means for monitoring the cache coherence of said at least one cache memory of said plurality of processing units based on the state transitions buffered in the transition buffer, in order to determining cache coherence violations.
